(19) United States
(12) Patent Application Publication
(10) Pub. No.: US 2002/0005237 A1
(43) Pub. Date: Jan. 17, 2002

(54) Tire for zero radius turns

(76) Inventors: Carl Musat, Avon Lake, OH (US); Robert Davis, Spencer, OH (US)

Correspondence Address: Timothy D. Bennett, One Cascade Plaza, 14th Floor, Akron, OH, 44308-1381, US

(21) Appl. No.: 09/892,072

(22) Filed: Jun. 26, 2001

Related U.S. Application Data
(60) Provisional application No. 60/213,910, filed on Jun. 26, 2000.

(51) Int. Cl. B60C 11/00

(52) U.S. Cl. 152/209.16

(57) ABSTRACT

A tire having a tread comprises a central raised rib having first and second lateral edges and extends about the tire and in generally circumferential manner. The central raised rib is substantially disposed on an equatorial plane of the tire. A plurality of transverse raised ribs has first and second radial edges and is axially disposed along a tread section width. Each of said transverse raised ribs is substantially V-shaped and connected to central raised rib.

This application claims the benefit of U.S. Provisional Application, Ser. No. 60/213,910, filed on Jun. 26, 2000, in Express Mail Label No. EL514600944US, by the same inventors, Carl Musat and Robert Davis, entitled TREAD FOR ZERO-TURN MOWER TIRE.

### BACKGROUND OF THE INVENTION

I. Field of the Invention

This invention relates to the art of vehicle tires, and more specifically to tires used on zero radius turn vehicles, or ZTR vehicles, especially as related to the tire tread.

II. Background of the Invention

Vehicles that permit zero radius turns have been gaining widespread popularity. Such vehicles generally work well for their intended purpose and are able to rotate one drive wheel in a forward direction while simultaneously rotating a second drive wheel in a reverse direction.

One aspect of ZTR vehicles is that the vehicles may be operated to turn, or steer, wherein the vehicle rotates solely about one drive wheel. The tread of the tire, about which the vehicle is turning, may cause damage to underlying turf in that it is not rolling over the surface thereof but rather rotating under the tread of the tire. As many tire treads are designed for traction, especially for traditional non-ZTR vehicles, such tread configuration may be not suitable for turf where a ZTR vehicle is rotating about one of the drive wheels.

Another aspect of tires is that the tire treads for ZTR vehicles, and more specifically lawn tractors or mowers, play a critical role in the effectiveness of mowing lawns. It is desirous to have a tire that has excellent traction capabilities so that underlying vegetation of hills and uneven terrain can be mowed. It is also important to have adequate traction when turning the mower.

Therefore, there is a strong need in the art to solve the aforementioned problems. A need exists to provide tread for a tire, which provides traction control without causing significant damage to the underlying turf.

### SUMMARY OF THE INVENTION

The present invention reduces all the aforementioned problems. A tire having a tread comprises a central raised rib having first and second lateral edges and extends about the tire in a generally circumferential manner. The central raised rib is substantially disposed on an equatorial plane of the tire. A plurality of transverse raised ribs has first and second radial edges and is axially disposed along a tread section width. Each of said transverse raised ribs is substantially V-shaped and connected to the central raised rib.

Accordingly, it is the object of the present invention to provide a tire having a tread wherein the plurality of transverse raised ribs and the central raised rib define a plurality of voids where each of the voids is defined between the first radial edge of one transverse raised rib, one of the lateral edges of the central raised rib, and the second radial edge of the next radially-spaced transverse raised rib.

Another object of the present invention is to provide a tire having a tread wherein the central raised rib and the transverse raised ribs to comprise a chamfer on the edges thereof for use of providing optimal traction for an associated vehicle.

Still yet, another object of the present invention is to provide a tire having a tread wherein the transverse raised ribs are integrally formed with the central raised rib.

Still yet, another object of the present invention is to provide a tire having a tread where each of the transverse raised ribs extends in a substantially equidistant length from the equatorial plane, across the tread section width of the tire and over a lateral edge such as the combination of the transverse raised ribs and central rib is substantially W-shaped in the axial direction.

Yet, another object of the present invention is to provide a tire having a tread wherein the central raised rib further comprises a tread depth being measured from a tire surface to a rib top, wherein the tread depth may range from approximately 0.25 inches to approximately 0.5 inches.

Still yet, another object of the present invention is to provide a tire having a tread wherein the V-shaped transverse raised ribs point in a rearwardly direction relative to a backend of an associated vehicle, meaning the tire is directional.

Another object of the present invention is to provide a tire having a tread wherein the tire is grooveless.

Still yet, another object of the present invention is to provide a tire having a tread wherein the ratio of the transverse rib width, trw, to center rib width, crw, is at least 1.5 to 1.

It is another object of the present invention is to provide a tire having a tread wherein the tread further comprises a net-to-gross ratio ranging from substantially 26% to 36%.

Further, another object of the present invention is to provide a tread wherein the netto-gross ratio is substantially 31%.

Yet, another object of the present invention is to provide a tire having a tread wherein an angle is formed between the first lateral edge of the central raised rib and the first radial edge of the transverse raised rib such that the angle may range from substantially 45 degrees to 85 degrees.

Further, another object of the present invention is to provide a tread wherein a radius interconnects the first lateral edge of the central raised rib and the first radial edge of the transverse raised rib.

Still, another object of the present invention is to provide a tire having a tread wherein a an angle is formed between the first lateral edge of the central raised rib and second radial edge of the transverse raised rib such that the angle ranges substantially 85 degrees to 125 degrees.

Another object of the present invention is to provide a tire having a tread wherein the radius interconnects the first lateral edge of the central rib and the second radial edge of the transverse rib.

Further, another object of the present invention is to provide a tire having a tread wherein the radius interconnecting the first lateral edge of the central rib and second radial edge of the transverse rib is substantially 0.5 inches.

Still yet, another object of the present invention is to provide a tire having a tread wherein the second radial edge comprises a connection end for connecting the second radial edge to the central raised rib, wherein each of the V-shaped transverse ribs further comprises an outer vertex and an inner vertex wherein the inner vertex has a vertex angle that may range from substantially 85 degrees to 125 degrees.

Yet, another object of the present invention is to provide improved traction for a zero turn radius vehicle.

It is another object of the present invention is to provide minimization of tearing of the associated turf.

### DEFINITION SECTION

“Axial” and “axially” are used herein to refer to lines or directions that are parallel to the axis of rotation of the tire.

“Circumferential” means lines or directions extending along the perimeter of the surface of the annular tread perpendicular to the axial direction.

“Radial” and “radially” are used to mean directions perpendicular to the axis of rotation of the tire.

“Lateral” means an axial direction.

“Footprint” means the contact patch or area of contact of the tire tread with a flat surface at zero speed and under normal load and pressure, including the area occupied by the tread elements.

“Net-to-gross” means the total area of ground contracting tread elements within the footprint divided by the gross area of the footprint.

“Rib” means a strip of rubber on the tread, which protrudes in a normal direction relative to the tire surface.

“Equatorial plane” means the plane perpendicular to the tire's axis of rotation and passing through the center of its tread.

### BRIEF DESCRIPTION OF DRAWINGS

The invention may take physical form in certain parts and arrangement of parts, a preferred embodiment of which will be described in detail in this specification and illustrated in the accompanying drawings which form a part hereof and wherein:

FIG. 1 is a perspective view of a Zero Turn Radius vehicle.

FIG. 1a is a perspective view of the present invention.

FIG. 2 is a side elevational view of the present invention.

FIG. 3 is a cross-sectional view of FIG. 2 taken along lines 3-3.

FIG. 4 is a front elevational view of the present invention.

FIG. 5 is a schematic drawing the tread pattern of the present invention.

FIG. 6 is a perspective view of the transverse raised ribs.

FIG. 6a is a cross section view of the transverse raised ribs taken at A-A′.

### DESCRIPTION OF THE PREFERRED EMBODIMENT

The present invention relates to tires 10 used on a Zero Turn Radius vehicle 1, which may include tractors and mowers, and especially as related to mowers utilizing independent drive units. The independent drive units provide the ZTR vehicle 1 with the ‘zero-turn-radius’ maneuverability. As ‘zero-turn-radius’ vehicles are well known in the art, as such will not be described further.

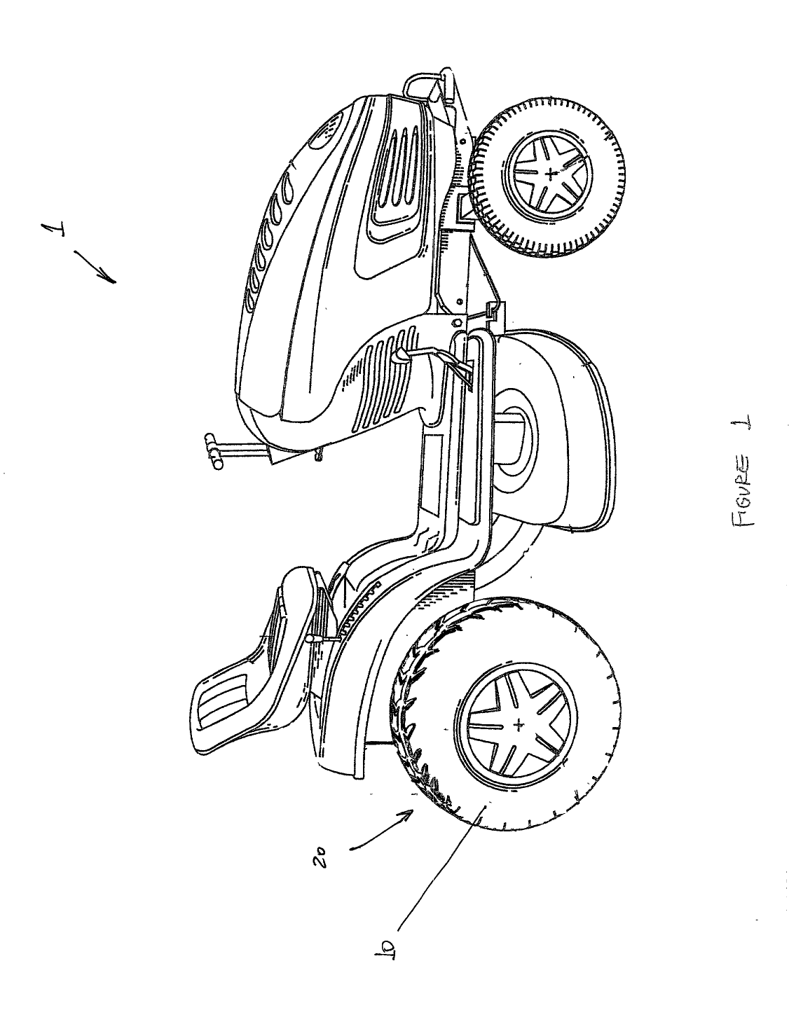

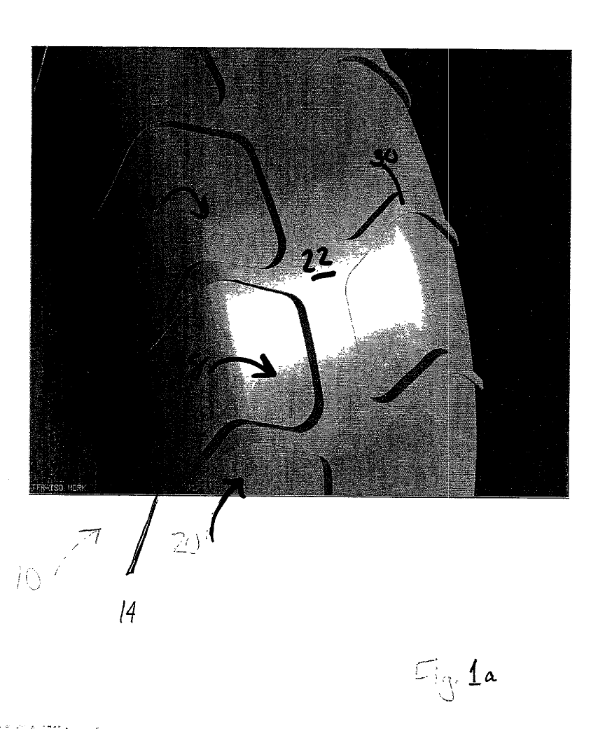

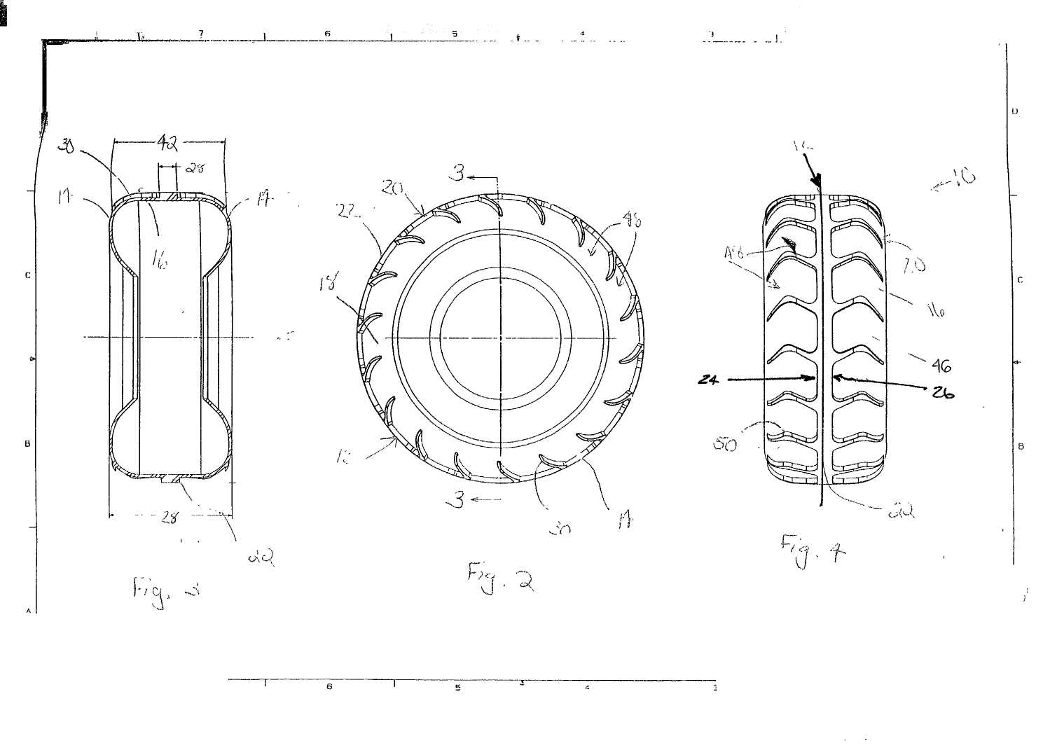

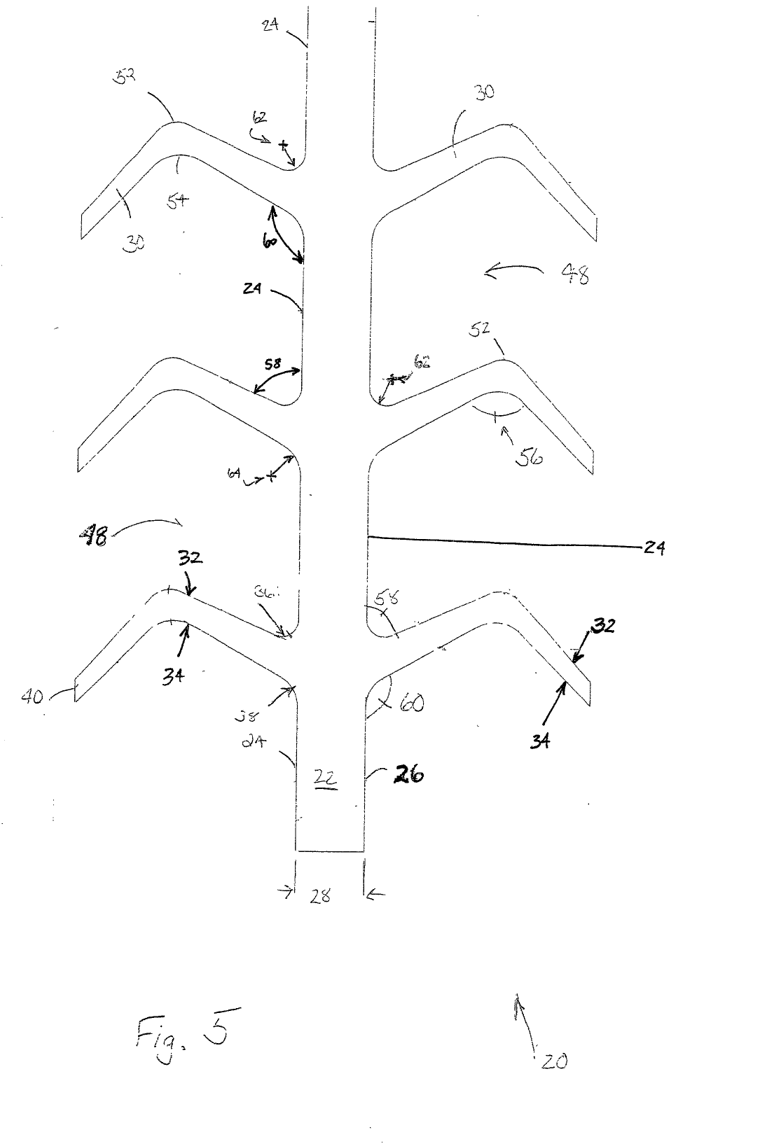

With reference to FIGS. 1 through 5, a tire 10 is shown having a pair of lateral edges 14 and a pair of sidewalls 18. Each of the sidewalls 18 communicates with one of the lateral edges 14. A tire tread 20 having a tread section width 42, shown most clearly in FIG. 3, is disposed substantially equidistantly between the pair of lateral edges 14. An equatorial plane 12 is defined as being located perpendicular to an axis of rotation of the tire 10 and passing substantially through the center of the tread 20 as shown in Figures. The tread 20 is comprised of a central raised rib 22 fashioned along the outer periphery of the tire 10 in a generally circumferential manner, as depicted clearly in FIG. 1a and 4. Additionally, the central raised rib 22 has first and second lateral edges 24, 26, which define an axial width 28 of the central raised rib 22. The dimensions of the axial width 28, referred to as aw, will be discussed in greater detail in a subsequent paragraph. However, as with any dimension disclosed herein, any width may be utilized for the central raised rib 22 as long as adequate traction is maintained without causing significant damage to the underlying turf.

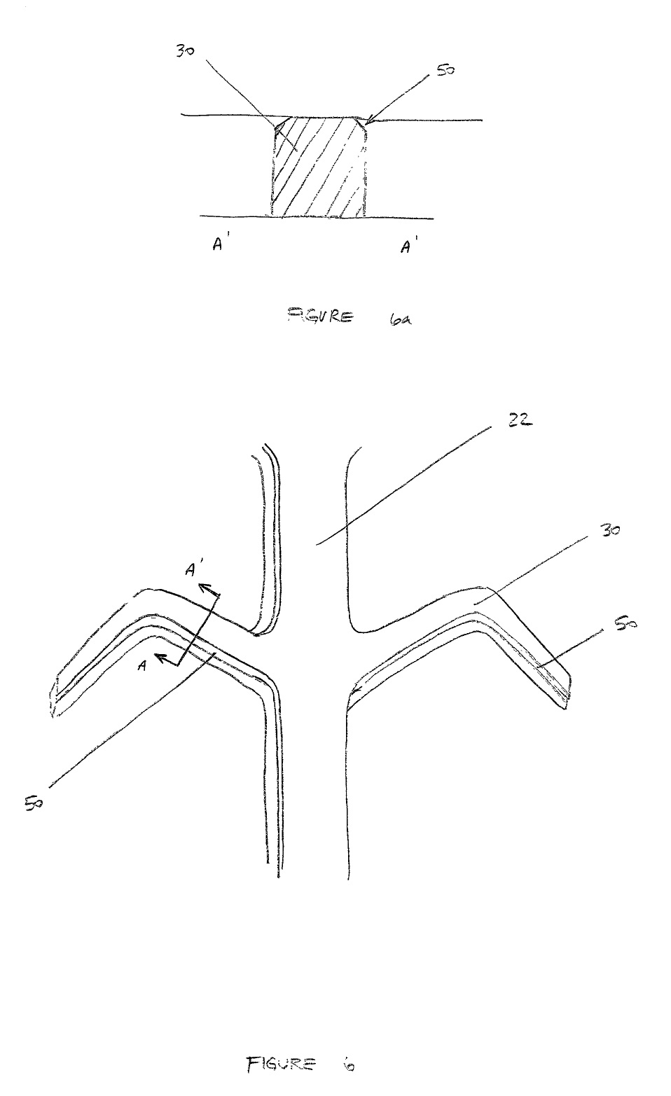

With continued reference to FIGS. 1 through 5, a plurality of transverse raised ribs 30 is shown having first and second radial edges 32, 34. The transverse raised ribs 30 are axially spaced along the tread section width 42 on opposite sides thereof where each of the transverse raised ribs 30 is substantially V-shaped and connected with the central raised rib 22. As shown in FIGS. 1a, 2, 4 and 5, the transverse raised ribs 30 are extended from and are integrally formed with the central raised rib 22 defining a plurality of voids 48. As best seen in FIG. 5, each of the voids 48 is defined between the first radial edge 32 of one transverse raised rib 30, one of the lateral edges 24 or 26 of the central raised rib 22, and the second radial edge 34 at the next radially space transverse raised rib 30. This formation, as detailed in the figures, maximizes traction for the mower especially as related to the zero-turn-radius tractors.

With continued reference to FIGS. 1a, 2 and 4, the transverse raised ribs 30 are disposed in pairs in a radial direction about the tire circumference. In the preferred embodiment, each transverse raised rib 30 of each pair is oppositely disposed about the central raised rib 22. In this manner, the transverse raised ribs 30 of each pair are aligned directly opposite each other. The transverse raised ribs 30 extend in a substantially equidistant length from the equatorial plane 12, across the tread section width 42 of the tire 10 and over to the lateral edge 14 of the tire 10 such that the combination of the transverse raised ribs 30 and central rib 22 is substantially W-shaped in the axial direction. Therefore the transverse raised ribs 30 are symmetric about the equatorial plane 12. In this manner, the transverse raised ribs 30 disposed directly opposite on each side of the central raised rib 22 are not staggered with respect to each other. However, it is also contemplated that the ribs 30, 30 may be disposed in a staggered or offset relationship about the equatorial plane 12.

Referencing all of the Figures, it is noted at this point that the tire 10 is preferably grooveless. That is to say that the tread 20 including the central raised rib 22 and transverse raised ribs 30 do not have grooves fashioned therein. In other words, the surface 46 of the tire 10 includes voids 48 and has protrusions extending therefrom in the way of transverse raised ribs 30 and a central rib 22 but does not contain grooves fashioned into any of the surfaces described above. In this manner, the tire 10 and the tire tread 20 is grooveless.

Referencing again FIG. 5 and also FIG. 6 and 6a, in the preferred embodiment of the present invention, the net-to-gross ratio is minimized to reduce the contact with the turf. This allows for optimal wear of the tire tread 20 along the central raised rib 22. The ratio of the area of the raised ribs 22 and 30 to the void area 48 is optimized as shown clearly depicted in FIG. 5. The net-to-gross ratio may have a general range between 26% and 36%. However, it is contemplated in an alternate embodiment that the net-to-gross ratio may extend from 20% to 50%. More precisely, the net-to-gross of the preferred embodiment is substantially 31%. FIGS. 6 and 6a, depict the raised ribs 22 and 30 having a chamfer 50 fashioned on the edges thereof for use in providing optimal traction for the tires 10 of the vehicle 1 of the present invention, and especially as related to the traction of the tires 10 in the reverse direction. The chamfer 50 may be fashioned at any angle chosen with sound engineering judgment, but in the preferred embodiment is fashioned at substantially 45 degrees. It is noted that the net-to-gross ratio is calculated related to the surface area of the tread 20 that is not chamfered. In other words, the area of the raised ribs 22 and 30 that has been chamfered is not included in calculating the net-to-gross ratio. In this manner, the net-to-gross may increase as the tire tread 20 wears with use because the area of the tread 20 will increase due to the chamfered edges 50. Therefore, the net-to-gross calculated herein is a net-to-gross ratio of the new or substantially un-used tire 10.

With reference again to FIG. 5, in the preferred embodiment, the depth of the tread 20 from the ground-engaging surface of the raised ribs 22 and 30 to the surface of the void 48 is substantially 0.35 inches. However, the depth of the raised ribs 22, 30, or the tread depth, may range from 0.25 to 0.5 inches.

With continued reference to FIG. 5, A first radial edge angle 58 is formed between the first lateral edge 24 of the central raised rib 22 and the first radial edge 32 of the transverse raised rib 30. The first radial edge angle 58 may range from substantially 45 degrees to 85 degrees. As shown in FIG. 5, the first radial edge angle 58 is approximately 65 degrees, but may reside within the range of 45 to 85 degrees. A first radius 62 interconnects the first lateral edge 24 of the central raised rib 22 and the first radial edge 32 of the transverse raised rib 30. The first radius 62 is substantially 0.25 inches to correlate with the 65 degree first radial edge angle 58. On the opposite side of the transverse raised rib 30, a second radial edge angle 60 is formed between the first lateral edge 24 of the central raised rib 22 and second radial edge 34 of the transverse raised rib 30. The second radial edge angle 60 may range from substantially 85 degrees to 125 degrees. As shown in FIG. 5, the second radial edge angle 60 is approximately 105 degrees. A second radius 64 interconnects the first lateral edge 24 of the central raised rib 22 and the second radial edge 34 of the transverse raised rib 30. The second radius 64 is substantially 0.5 inches to correlate with 105-degree angle of the second radial edge angle 60.

Referencing again all of the FIGS. 1 through 5, each transverse rib 30 comprises first and second connection ends 36, 38 for connecting the transverse raised rib 30 to the central rib 22. Additionally, each transverse raised rib 30 has a distal end 40, which extends over to the lateral edge 14 of the tire 10. The transverse ribs 30 further comprise an outer vertex 52 and an inner vertex 54 wherein the inner vertex 54 has a vertex angle 56 ranging from substantially 85 degrees to 125 degrees. As shown in FIG. 5, the inner vertex angle 56 is substantially 105 degrees. A ratio is defined of the radial distance from the second connection end 38 to the inner vertex 54, iv, to the radial distance from the second connection end 38 to the outer vertex 52, ov, which may be substantially within the range of 0.73 to 0.79. This range provides for optimal performance of the tire tread 20. However, the ratio iv/ov may generally range from substantially 0.65 to 0.87. Of course these radial distances, the vertex angle 56, and first and second radial angles 32, 34 may be any dimension chosen with sound engineering judgment provided that traction is maintained and damage to the underlying turf is minimal. As is evident from these angles and radial distances, the V-shaped transverse raised ribs 30 point in a rearwardly direction relative to a backend of the associated vehicle 1, meaning the tire 10 is directional.

Referencing again FIGS. 1 through 5, in the preferred embodiment, the tread section width 42 may range between substantially 7.5 inches and substantially 8.12 inches, but is not limited thereto. Additionally, the plurality of transverse raised ribs 30 extends a distance, which may range from substantially 7.2 inches to substantially 7.8 inches measured from one distal end 40 of one transverse raised rib 30 to the distal end 40 of the opposing transverse raised rib 30. In this manner, the ratio, trw/tsw, of the transverse rib width trw, to the tread section width tsw, is substantially within the range of 0.93 to 0.99. However, the ratio trw/tsw may range from between 0.87 to 1.05. The transverse rib 30 width, trw, and the axial width 28, aw, of the center rib 22 also form a ratio trw/aw, which is at least 1.5 to 1. In some instances it may be 2 to 1 or even 5 to 1. The present embodiment described herein provides for optimal performance of the zero-turn-radius vehicle 1 while minimizing tearing of the turf on which the vehicle 1 is traversing.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

What is claimed is:

1. A tire having a tread, comprising:
a central raised rib having first and second lateral edges and extending about the tire in a generally circumferential manner, said central raised rib being substantially disposed on an equatorial plane of the tire;
a plurality of transverse raised ribs having first and second radial edges and being axially spaced along a tread section width on opposite sides of said central raised rib, each of said transverse raised ribs being substantially V-shaped and connected to said central raised rib.

2. A tire having a tread, comprising:
a central raised rib extending about the tire in a generally circumferential manner, said central raised rib being substantially disposed on an equatorial plane of the tire;
a plurality of transverse raised ribs being axially spaced along a tread section width; and,
wherein each of said transverse raised ribs extends in a substantially equidistant length from the equatorial plane, across said tread section width of the tire and over a lateral edge such that the combination of said central raised rib and any pair of transverse raised ribs oppositely disposed about the longitudinal rib and is substantially W-shaped in the axial direction.

3. The tire having the tread of claim 1, wherein said transverse rib width to central rib width forms a ratio trw/aw being at least about 1.5 to 1.

4. The tire having the tread of claim 1, wherein said tread further comprises a net to gross ratio ranging from substantially 20% to substantially 50%.

5. A tire having a tread, comprising:
a central raised rib extending about the tire in a generally circumferential manner, said central raised rib being substantially disposed on an equatorial plane of the tire;
a plurality of transverse raised ribs being axially spaced along a tread section width; and,
wherein said tread includes a net to gross ratio that ranges from substantially 26% to 36%.

6. The tire having the tread of claim 1, wherein an angle is formed between said first lateral edge of said central raised rib and said first radial edge of said transverse rib, said angle ranging from substantially 45 degrees to substantially 85 degrees.

7. The tire having the tread of claim 1, wherein an angle is formed between said first lateral edge of said central raised rib and said first radial edge of said transverse rib, said angle being substantially within the range of 45 to 85 degrees.

8. The tire having the tread of claim 6, wherein a radius interconnects said first lateral edge of said central raised rib and said first radial edge of said transverse rib.

9. The tire having the tread of claim 1, wherein an angle is formed between said first lateral edge of said central raised rib and said second radial edge of said transverse rib, said angle ranging from substantially 85 degrees to substantially 125 degrees.

10. The tire having the tread of claim 1, wherein an angle is formed between said first lateral edge of said central raised rib and said second radial edge of said transverse rib, said angle being substantially 105 degrees.

11. The tire having the tread of claim 1, wherein a radius interconnects said first lateral edge of said central raised rib and said second radial edge of said transverse rib.

12. The tire having the tread of claim 11, wherein said radius is substantially 0.5 inches.

13. A tire having a tread, comprising:
a central raised rib having first and second lateral edges and extending about the tire in a generally circumferential manner, said central raised rib being substantially disposed on an equatorial plane of the tire;
a plurality of transverse raised ribs having first and second radial edges and being axially spaced along a tread section width on opposite sides of said central raised rib, each of said transverse raised ribs being substantially V-shaped and connected to said central raised rib; and,
wherein said second radial edge comprises a connection end for connecting said second radial edge to said central raised rib, each of said V-shaped transverse ribs further comprises an outer vertex and an inner vertex, said inner vertex having a vertex angle, said vertex angle ranging from substantially 85 degrees to substantially 125 degrees.

14. The tire having the tread of claim 13, wherein the ratio of the radial distance iv, from said connection end to said inner vertex, to the radial distance ov, from the connection end to said outer vertex, is substantially in the range of 0.73 to 0.79.

15. The tire having the tread of claim 1, wherein said central raised rib further comprises a tread depth, said tread depth being measured from a tire surface to a top of the rib, said tread depth being in the range of approximately 0.25 inches to approximately 0.5 inches.

16. The tire having the tread of claim 15, wherein said raised tread depth is substantially 0.35 inches.

17. The tire having the tread of claim 1, wherein the tire is grooveless.

18. The tire having the tread of claim 1, wherein said tread section width ranges between substantially 7.5 inches and substantially 8.12 inches.

19. The tire having the tread of claim 1, wherein the ratio, trw/tsw, of the transverse rib width trw, to the tread section width tsw, is substantially within the range of 0.93 to 0.99.

20. The tire having the tread of claim 1, wherein any pair of said plurality of transverse raised ribs oppositely disposed about said central rib extends across said tread section width a transverse rib width ranging from substantially 7.2 inches to substantially 7.8 inches.

21. The tire having the tread of claim 1, wherein said central raised rib and said transverse raised ribs further comprise a chamfer on the edges thereof for use in providing optimal traction for an associated vehicle.

22. The tire having the tread of claim 1, wherein said plurality of transverse raised ribs is integrally formed with said central raised rib.

23. The tire having the tread of claim 1, wherein the height of said traverse raised rib and the height of said central raised rib is substantially equal.

24. The tire having the tread of claim 1, wherein the difference in the height of said traverse raised rib and the height of said central raised rib is less than 5%.

25. The tire having the tread of claim 1, wherein the width of said central raised rib is substantially uniform.

26. The tire having the tread of claim 1, wherein said transverse raised ribs spaced along a tread section width on opposite sides of said central raised rib are not staggered.

27. A tire for a tread, comprising:
a pair of lateral edges;
a pair of sidewalls, each sidewall communicating with one of said lateral edges;
a tread section width located between said pair of lateral edges;
an equatorial plane located perpendicular to an axis of rotation and passing through said tire tread;
a net-to-gross ratio substantially within the range of 26% to 36%;
said tire tread further comprising:
a substantially continuous central raised rib, said central raised rib extending circumferentially about said tire and being disposed on said equatorial plane, said central raised rib further comprising an axial width aw;
a plurality of pairs of transverse raised ribs,
each transverse raised rib having first and second connection ends and a distal end,
each transverse raised rib being substantially V-shaped and integrally formed with said central raised rib,
said transverse ribs axially extending a substantially equidistant length from said central raised rib across said tread section width and over one of said lateral edges such that the combination of the pair of transverse raised ribs and said central raised rib being substantially W-shaped in the axial direction,
said plurality of pairs of transverse raised ribs being radially spaced about the circumference of said tire such that a plurality of voids are defined between a first radial edge of one transverse raised rib, one lateral edge of said central raised rib, and a second radial edge of the next radially spaced transverse raised rib,
said transverse raised ribs and central raised rib further comprising a chamfer on the edges thereof for use in providing optimal traction for the associated riding mower,
said transverse ribs having a transverse rib width which forms a ratio trw/aw with said central raised rib of at least 1.5 to 1,
said V-shaped transverse raised ribs pointing in a rearwardly direction relative to a back end of the associated riding mower, and;
a first radial edge angle formed between said first lateral edge of said central raised rib and said first radial edge of said transverse rib being substantially within the range of 45 to 85 degrees, said first lateral edge and first radial edge being interconnected by a first radius;
a second radial edge angle formed between said first lateral edge of said central raised rib and said second radial edge of said transverse rib being substantially within the range of 85 to 125 degrees, said first lateral edge and second radial edge being interconnected by a first radius.
